(19) United States
(12) Patent Application Publication
(10) Pub. No.: US 2019/0103072 A1
(43) Pub. Date: Apr. 4, 2019

(54) CHARGING CONTROL METHOD AND RELATED ELECTRONIC DEVICE

(71) Applicant: Lenovo (Beijing) Co., Ltd., Beijing (CN)

(72) Inventors: Youze LI, Beijing (CN); Jun SHI, Beijing (CN)

(21) Appl. No.: 16/148,487

(22) Filed: Oct. 1, 2018

(30) Foreign Application Priority Data
Sep. 30, 2017 (CN) 201710916761.5

(51) Int. Cl. G09G 5/10

(52) U.S. Cl. CPC G09G 5/10; G09G 2320/041; G09G 2320/0626

(57) ABSTRACT

The present disclosure provides a charging control method. The method includes obtaining, through a processor, a first ambient temperature of an electronic device; based on the ambient temperature, determining, through a processor, a first refresh rate corresponding to the ambient temperature; and controlling, through a processor, a display screen of the electronic device to refresh at the first refresh rate so that each pixel of the display screen is charged in a refresh cycle.

### CROSS-REFERENCES TO RELATED APPLICATIONS

This application claims the priority to Chinese Patent Application No. 201710916761.5, entitled “Charging Control Method and Related Electronic Device”, filed on Sep. 30, 2017, the entire content of which is incorporated herein by reference.

### FIELD OF THE DISCLOSURE

The present disclosure relates to the field of device charging controlling technologies and, more particularly, relates to a charging control method and a related electronic device.

### BACKGROUND

In order to deliver a better user experience, devices such as mobile phones usually are designed with a higher screen-to-body ratio. As such, a lower border of the screen of the device needs to be made as narrow as possible.

To reduce the size of the lower border of the screen, it is necessary to reduce the number of signal lines in that region. When the number of the signal lines is reduced, correspondingly, each signal line needs to charge more pixels in each row of pixels of the screen. Accordingly, charging time of each pixel in the screen may be reduced, and the pixels of the screen may be insufficiently charged. As a result, the screen display may be dim and negatively affect the user experience.

### BRIEF SUMMARY OF THE DISCLOSURE

The present disclosure provides a charging control method in an electronic device. The method includes obtaining, through a processor, a first ambient temperature of an electronic device; based on the ambient temperature, determining, through a processor, a first refresh rate corresponding to the ambient temperature; and controlling, through a processor, a display screen of the electronic device to refresh at the first refresh rate so that each pixel of the display screen is charged in a refresh cycle.

Another aspect of the present disclosure provides a method for charging pixels in an electronic device. The method includes obtaining, through a processor, an ambient temperature of the electronic device; based on the ambient temperature, determining, through a processor, charging time corresponding to the ambient temperature; and controlling, through a processor, a display screen of the electronic device to charge each pixel of the display screen during the charging time.

Another aspect of the present disclosure provides an electronic device. The electronic device includes a processor; a display screen coupled to the processor; and a storage medium coupled to the processor and configured to store an executable program that, when executed by the processor, causes the processor to: obtain an ambient temperature of the electronic device; based on the ambient temperature, determine a refresh rate corresponding to the ambient temperature; and control the display screen to refresh at the refresh rate so that each pixel of the display screen is charged in a refresh cycle.

The present disclosure also provides a related electronic device. The electronic device may include a processor, a display screen coupled to the processor; and a storage medium coupled to the processor and configured to store an executable program. When the executable program is executed by the processor, it may cause the processor to obtain an ambient temperature of an environment where the electronic device is located. Based on the ambient temperature, the processor may be configured to determine a refresh rate corresponding to the ambient temperature. And the processor may be further configured to control the display screen to refresh at the refresh rate to charge each pixel of the display screen.

Other aspects of the present disclosure can be understood by those skilled in the art in light of the description, the claims, and the drawings of the present disclosure.

### BRIEF DESCRIPTION OF THE DRAWINGS

To explain technical solutions in the embodiments of the present disclosure more clearly, in the following, it briefly introduces the accompanying drawings used to describe the embodiments. It should be noted that the accompanying drawings in the following description are merely some embodiments of the present disclosure. For those skilled in the art, other illustrations may also be obtained based on the accompanying drawings without any additional creativity and efforts.

FIG. 1 is a flow diagram of a charging control method according to some embodiments of the present disclosure.

FIG. 2 is a flow diagram of another charging control method according to some embodiments of the present disclosure.

FIG. 3 is a schematic diagram of an electronic device according to some embodiments of the present application.

FIG. 4 is a schematic diagram of another electronic device according to some embodiments of the present application.

### DETAILED DESCRIPTION

The technical solutions in the embodiments of the present disclosure are clearly and completely described below with reference to the accompanying drawings. It is apparent that the described embodiments are merely some but not all of the embodiments of the present disclosure. All of the other embodiments obtained by a person of ordinary skills in the art based on the embodiments of the present disclosure without creative efforts shall fall in the protection scope of this application.

Some embodiments of present disclosure provide a charging control method. The method may be implemented by an electronic device with a display screen that may include a liquid crystal display (LCD).

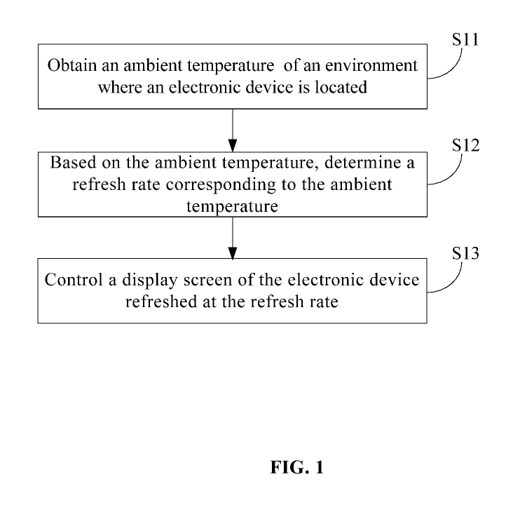

FIG. 1 is a flow diagram of a charging control method according to some embodiments of the present disclosure. Referring to FIG. 1, the method may include the following steps.

In S11: An ambient temperature of an environment where an electronic device is located may be obtained.

A temperature measurement device coupled to a processor may collect the ambient temperature of the environment where the electronic device is located. The temperature measurement device may include a P-sensor, and/or a temperature sensor, and/or a thermosensitive circuit, etc. The thermosensitive circuit may be integrated in a display screen.

If the temperature measurement device is a P-sensor, the P-sensor may be configured to receive an infrared signal emitted by an external object and to determine the ambient temperature by an infrared wavelength.

If the temperature measurement device is a thermosensitive circuit, a temperature corresponding to a resistance of the thermosensitive circuit may be determined according to the resistance of the thermosensitive circuit, and the corresponding temperature is the ambient temperature.

In S12: Based on the ambient temperature, a refresh rate corresponding to the ambient temperature may be determined.

In some embodiments, the refresh rate corresponding to the ambient temperature may be determined according to a preset correspondence between the ambient temperature and the refresh rate.

In some embodiments, the refresh rate corresponding to the ambient temperature may be determined according to charging saturation time of a capacitor of a pixel in the display screen at the ambient temperature. That is, the refresh rate corresponding to the ambient temperature is associated with the charging saturation time of the capacitor of the pixel in the display screen at the ambient temperature.

A linear relationship of the charging saturation time and the capacitor of the pixel in a normal operating temperature range (e.g., −20° C. to 70° C.) may be obtained through tests. That is, a system may obtain a correspondence between the charging saturation time of the capacitor of the pixel in the display screen and the ambient temperature.

In some embodiments, the higher the ambient temperature is, the higher the refresh rate may become. And the lower the ambient temperature is, the lower the refresh rate may be.

In S13: The display screen of the control electronic device may be controlled to refresh frames of images at the determined refresh rate so that a capacitor of each pixel of the display screen has sufficient charging time to reach a saturation state.

In some embodiments of the present application, the display screen of the electronic device may charge the capacitor of each pixel of the display screen according to the determined refresh rate so that the capacitor of each pixel of the display screen is charged once and reaches full charge within a period to refresh each frame of a screen image once.

According to the charging control method provided by the embodiments of the present disclosure, the refresh rate corresponding to the ambient temperature may be determined based on the ambient temperature of the environment where the electronic device is located. And the display screen of the electronic device may be controlled to perform the refresh process at the refresh rate so that the capacitors have the sufficient charging time to reach the saturation state. Accordingly, a screen brightness is not reduced with a reduction of the number of the signal lines.

In addition, with the charging control method provided by the embodiments of the present application, the brightness level of the display screen remains consistent under different ambient temperatures. And it can overcome the problem of serious attenuation of the brightness level of the display screen in a low temperature environment.

In some embodiments, the display screen of the electronic device may be refreshed at a first refresh rate when the electronic device is at a first ambient temperature. And the capacitor/capacitors of each pixel of the display screen may be charged during a first charging time, respectively, to reach a saturation state.

The display screen of the electronic device may be refreshed at a second refresh rate when the electronic device is at a second ambient temperature. And the capacitor/capacitors of each pixel of the display screen may be charged during a second charging time, respectively, to reach a saturation state.

The first ambient temperature may be different from the second ambient temperature, the first refresh rate may be different from the second refresh rate, and the first charging time may be different from the second charging time. And a first brightness level that is produced by the capacitor/capacitors of each pixel of the display screen charged to the saturation state at the first ambient temperature may approximately equal to a second brightness level that is produced by the capacitor/capacitors of each pixel of the display screen charged to the saturation state at the second ambient temperature.

In some embodiments of the present disclosure, if the first ambient temperature is higher than the second ambient temperature, then the first refresh rate may be higher than the second refresh rate, and the first charging time may be shorter than the second charging time.

At a same ambient temperature, it may take a same length of time to charge the capacitors of different pixels to reach a saturation state.

In some embodiments, controlling the display screen of the electronic device to perform the refresh process at the refresh rate may include: controlling a controller of the display screen to modify charging time parameters of the capacitor/capacitors of each pixel of the display screen based on the refresh rate.

In some embodiments of the present disclosure, the charging time parameters of each pixel may be obtained according to the preset correspondence between the refresh rate and the charging time, or may be calculated according to the refresh rate.

In some embodiments, modifying the charging time parameters of the capacitor of each pixel of the display screen based on the refresh rate may include: taking a period for refreshing each frame of the screen image once as a sum of the charging time for charging the capacitor of each pixel of the display screen once. And the refresh rate is the number of refreshing times of the screen image per second.

In some embodiments, the time for the capacitor of each pixel to be charged to reach a saturation state may be calculated as follows.

According to the refresh rate, the time for refreshing each frame of the screen image may be calculated, and the time for refreshing each frame of the screen image is a reciprocal of the refresh rate.

The time for refreshing each frame of the screen image may be divided by the number of rows of pixels contained in each frame of the screen image to obtain the time for charging the capacitor/capacitors of each row of pixels to reach the saturation state.

And the time for charging the capacitor/capacitors of each row of pixels to reach the saturation state may be divided by the number of the capacitors of the pixels to be charged per signal line to obtain the time for charging the capacitor of each pixel to reach to the saturation state.

Assume that the number of the capacitors of the pixels to be charged per signal line is n, and the number of the pixels contained in each frame of the display screen is x * y. The parameter x represents the number of rows of pixels and y represents the number of columns of pixels. Each of the signal lines is configured to charge the capacitors of the n pixels one by one. That is, the capacitor of one pixel is charged to the saturation state, and then the capacitor of the next pixel may be charged. And a plurality of signal lines simultaneously charge the capacitors of the corresponding pixels. During charging, the capacitors of the pixels are charged row by row. That is, the capacitors of the pixels in one row are charged to a saturation state, and then the capacitors of the pixels in the next row may be charged. Assuming that the determined refresh rate is P, an equation for calculating the time t for charging the capacitor of each pixel to the saturation state may be:

$$t = \frac{1}{P * x * n}$$

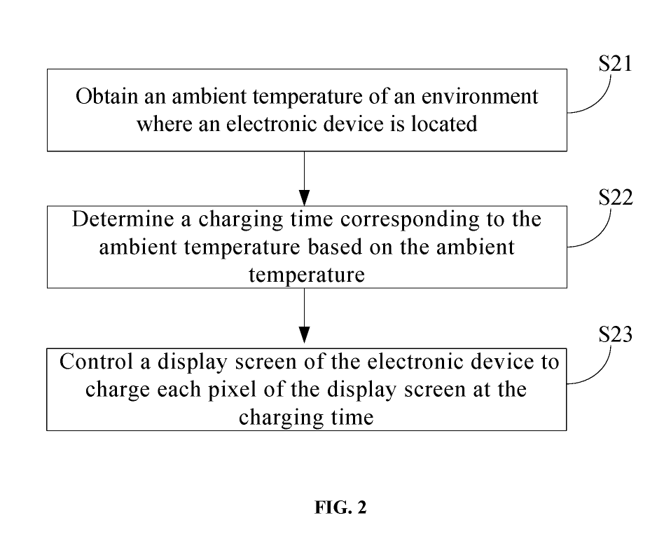

FIG. 2 is a flow diagram of another charging control method according to some embodiments of the present disclosure. Referring to FIG. 2, the method may include the following steps.

In S21: An ambient temperature of an environment where an electronic device is located may be obtained.

The ambient temperature of the environment where the electronic device is located may be collected by a temperature measurement device. The temperature measurement device may include a P-sensor, and/or a temperature sensor, and/or a thermosensitive circuit, etc. The thermosensitive circuit may be integrated in a display screen.

If the temperature measurement device is a P-sensor, the P-sensor may be configured to receive an infrared signal emitted by an external object and determine the ambient temperature by an infrared wavelength.

If the temperature measurement device is a thermosensitive circuit, the temperature corresponding to a resistance of the thermosensitive circuit may be determined according to the resistance of the thermosensitive circuit, and the temperature is the ambient temperature.

In S22: Charging time corresponding to the ambient temperature may be determined based on the ambient temperature.

In some embodiments, the charging time corresponding to the ambient temperature may be determined according to a preset correspondence between the ambient temperature and the charging time. The charging time may refer to a period for charging a pixel capacitor to reach a saturation state.

In S23: A display screen of the electronic device may be controlled to charge a capacitor of each pixel of the display screen at the determined charging time.

According to the charging control method provided by the embodiment of the present disclosure, the charging time of the capacitor of each pixel of the display screen may be determined according to the ambient temperature of electronic device so that the capacitor of each pixel has the sufficient charging time to reach the saturation state, thereby a screen brightness not be reduced with reduction of the number of signal lines. In addition, with the charging control method provided by the embodiments of the present disclosure, the brightness of the display screen remains consistent under different ambient temperatures, thereby overcoming the problem of serious attenuation of the brightness of the display screen in a low temperature environment.

In some embodiments, the capacitor of each pixel of the display screen may have a first charging time, respectively, to reach a saturation state when the electronic device is at a first ambient temperature. The capacitor of each pixel may have a second charging time, respectively, to reach a saturation state when the electronic device is at a second ambient temperature.

The first ambient temperature may be different from the second ambient temperature, and the first charging time may be different from the second charging time. At the first ambient temperature, a first brightness level that is produced by the capacitor of each pixel of the display screen charged to the saturation state may approximately equal to a second brightness level that is produced by the capacitor of each pixel of the display screen charged to the saturation state at the second ambient temperature.

In some embodiments of the present disclosure, if the first ambient temperature is higher than the second ambient temperature, the first charging time may be shorter than the second charging time.

At a same ambient temperature, charging periods for charging capacitors of different pixels to reach the saturation state may be identical.

In some embodiments, the charging control method provided by the present disclosure may further include: based on the determined charging time, a refresh rate corresponding to the charging time may be determined.

In some embodiments, the refresh rate corresponding to the charging time may be determined according to a preset correspondence between the charging time and the refresh rate, or may be calculated according to the charging time. The calculation may include the following steps.

The charging time of the capacitor of each pixel may be multiplied by the number of capacitors of the pixels to be charged per each signal line to obtain a period for the capacitors of each row of pixels to be charged to the saturation state.

The time for charging the capacitors of each row of pixels to reach the saturation state may be multiplied by the number of rows of pixels contained in each frame of a screen image to obtain the time for charging the capacitors of all pixels in each frame of the screen image to reach the saturation state.

The refresh rate corresponding to the charging time is a reciprocal of the time for charging the capacitors of all the pixels in each frame of the screen image to reach the saturation state.

Assume that the number of the capacitors of the pixels to be charged by each signal line is n, and the number of the pixels contained in each frame of the display screen is x * y. The parameter x represents the number of rows of pixels and y represents the number of columns of pixels. Each of the signal lines is configured to charge the capacitors of the n pixels one by one. That is, the capacitor of one pixel is charged to the saturation state, and then the capacitor of the next pixel may be charged. And a plurality of signal lines simultaneously charge the capacitors of the corresponding pixels. During charging, the capacitors of the pixels are charged row by row. That is, the capacitors of the pixels in one row are charged to a saturation state, and then the capacitors of the pixels in the next row may be charged. Assuming that the time for charging the capacitor of each pixel to a saturation sate is t, an equation for calculating a refresh rate P corresponding to the time t may be:

$$P = \frac{1}{t * x * n}$$

The control display may be then configured to perform a refresh process at the determined refresh rate.

In some embodiments of the present application, after the charging time of the capacitors of the pixels of the display screen is modified, the refresh rate of the display screen may be modified accordingly.

In some embodiments, when the electronic device is at the first ambient temperature, the capacitor of each pixel of the display screen may have the respective first charging time to reach the saturation state, and the display screen may perform the refresh process at the first refresh rate. When the electronic device is at the second ambient temperature, the capacitor of each pixel of the display screen may have the respect second charging time to reach the saturation state, and the display screen may perform the refresh process at the second refresh rate.

The first ambient temperature may be different from the second ambient temperature, the first charging time may be different from the second charging time, and the first refresh rate may be different from the second refresh rate. The first brightness level that is produced by the capacitor of each pixel of the display screen charged to the saturation state at the first ambient temperature may approximately equal to the second brightness level that is produced by the capacitor of each pixel of the display screen charged to the saturation state at the second ambient temperature.

In some embodiments of the present disclosure, if the first ambient temperature is higher than the second ambient temperature, the first charging time may be shorter than the second charging time, and the first refresh rate may be higher than the second refresh rate.

At a same ambient temperature, periods for charging capacitors of different pixels to reach the saturation state may be identical.

In some embodiments, a controller of the display screen may be configured to modify a charging time parameter of the capacitor of each pixel of the display screen according to a charging time parameter delivered by a processor, so that the capacitor of each pixel of the display screen may be charged according to the charging time parameter delivered by the processor.

In some embodiments, the controller of the display screen may be configured to modify a refresh rate parameter of the display screen according to a refresh rate parameter delivered by the processor, so that the display screen may perform a refresh process according to the refresh rate parameter delivered by the processor.

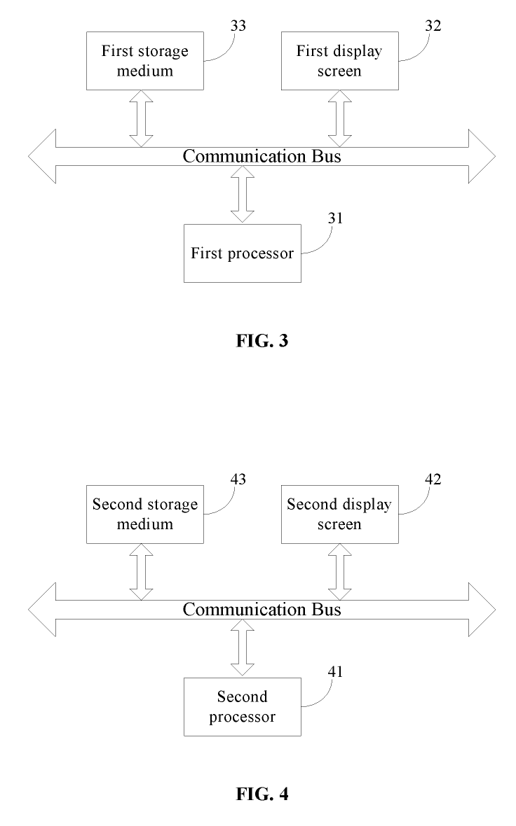

Embodiments of the present disclosure further provide an electronic device. FIG. 3 shows a schematic diagram of the electronic device according to some embodiments of the present disclosure. The electronic device may include: a first processor 31, a first display screen 32, and a first storage medium 33 communicatively coupled with the first processor 31.

The first processor 31 may be configured to obtain an ambient temperature of an environment where the electronic device is located. The first processor 31 may be further configured to determine a refresh rate corresponding to the ambient temperature based on the ambient temperature and control the first display screen 32 to perform charging a capacitor of each pixel of the display screen 32 at the determined refresh rate, so that the capacitor of each pixel of the display screen 32 may have sufficient charging time to reach a saturation state.

The first storage medium 33 may be configured to store a program, and the first processor 31 may execute the program to realize the methods stated above.

The electronic device provided by the embodiments of the present disclosure may determine the refresh rate corresponding to the ambient temperature based on the ambient temperature of the environment where the electronic device is located and control the display screen of the electronic device to perform the refresh process at the refresh rate so that the capacitor of each pixel of the display screen has sufficient charging time to reach the saturation state, thereby a screen brightness level is not being reduced with a reduction of the number of signal lines.

In addition, with the electronic device provided by the embodiments of the present disclosure, a brightness level of the display screen remains consistent under different ambient temperatures, thereby overcoming the problem of serious attenuation of the brightness of the display screen in a low temperature environment.

In some embodiments, the first display screen 32 may perform the refresh process at a first refresh rate when the electronic device is at a first ambient temperature, and the capacitor of each pixel of the first display screen 32 may have a first charging time, respectively, to reach a saturation state.

The first display screen 32 may perform the refresh process at a second refresh rate when the electronic device is at a second ambient temperature, and the capacitor of each pixel of the first display screen 32 may have a second charging time, respectively, to reach a saturation state.

The first ambient temperature may be different from the second ambient temperature, the first refresh rate may be different from the second refresh rate, and the first charging time may be different from the second charging time. A first brightness level that is produced by the capacitor of each pixel of the display screen charged to the saturation state at the first ambient temperature may approximately equal to a second brightness level that is produced by the capacitor of each pixel of the display screen charged to the saturation state at the second ambient temperature.

In some embodiments of the present disclosure, if the first ambient temperature is higher than the second ambient temperature, the first refresh rate may be higher than the second refresh rate, and the first charging time may be shorter than the second charging time.

At a same ambient temperature, periods for charging capacitors of different pixels to reach to the saturation time may be identical.

In some embodiments, the display screen 32 may include a controller. And the processor 31 may be configured to control the controller to modify charging time parameters of the capacitor of each pixel of the display screen 32 based on the refresh rate.

In some embodiments, the processor 31 may be further configured to refresh each frame of a screen image over a time period that is a sum of the charging time for charging the capacitor/capacitors of each pixel of the display screen. And the refresh rate is the number of refreshing times of the screen image per second.

The electronic device provided by the present disclosure may include a temperature measurement device. The temperature measurement device may include a P-sensor, and/or a temperature sensor, and/or a thermosensitive circuit, etc. The thermosensitive circuit may be integrated in a display screen.

If the temperature measurement device is a P-sensor, the P-sensor may be configured to receive an infrared signal emitted by an external object and to determine the ambient temperature by an infrared wavelength.

If the temperature measurement device is a thermosensitive circuit, a temperature corresponding to a resistance of the thermosensitive circuit may be determined according to the resistance of the thermosensitive circuit, and the corresponding temperature is the ambient temperature.

Corresponding to the embodiments of the method, the present disclosure further provides another electronic device. FIG. 4 shows a schematic diagram of the other electronic device according to some embodiments of the present disclosure. The electronic device may include: a second processor 41, a second display screen 42 and a second storage medium 43 communicatively coupled with the second processor 41.

The second processor 41 may be configured to obtain an ambient temperature of an environment where the electronic device is located. The second processor 41 may be further configured to determine charging time corresponding to the ambient temperature based on the ambient temperature and control the second display screen 42 to charge a capacitor of each pixel of the display screen 42 within the charging time.

The second storage medium 43 may be configured to store a program, and the second processor 41 executes the program to realize the methods stated above.

The electronic device provided by the embodiments of the present disclosure may determine the charging time corresponding to the ambient temperature based on the ambient temperature of the environment where the electronic device is located and control the display screen of the electronic device to charge the capacitor/capacitors of each pixel of the display screen within the charging time so that the capacitor of each pixel of the display screen has the sufficient charging time to reach the saturation state, thereby a screen brightness level is not being reduced with a reduction of the number of signal lines.

In addition, with the electronic device provided by the embodiments of the present disclosure, a brightness level of the display screen may remain consistent under different ambient temperatures, thereby overcoming the problem of serious attenuation of the brightness levels of the display screen in a low temperature environment.

In some embodiments, each pixel of the display screen 42 may be charged during a first charging time, respectively, to reach a saturation state in response to the electronic device being at a first ambient temperature. And the capacitor/capacitors of each pixel of the display screen 42 may be charged during a second charging time, respectively, to reach a saturation state in response to the electronic device being at a second ambient temperature.

The first ambient temperature may be different from the second ambient temperature, and the first charging time may be different from the second charging time. And a first brightness level produced by the capacitor/capacitors of each pixel of the display screen 42 charged to the saturation state at the first ambient temperature may approximately equal to a second brightness level produced by the capacitor/capacitors of each pixel of the display screen 42 charged to the saturation state at the second ambient temperature.

In some embodiments of the present disclosure, if the first ambient temperature is higher than the second ambient temperature, the first charging time may be shorter than the second charging time.

In some embodiments, the second processor 41 may be configured to determine a refresh rate according to the charging time, and control the second display screen 42 to be refreshed at the refresh rate.

In some embodiments, each pixel of the display screen 42 may be charged during a first charging time, respectively, to reach a saturation state in response to the electronic device being at a first ambient temperature. The second display screen 42 may be refreshed at a first refresh rate. And the capacitor/capacitors of each pixel of the display screen 42 may be charged during a second charging time, respectively, to reach a saturation state in response to the electronic device being at a second ambient temperature. The second display screen 42 may be refreshed at a second refresh rate.

The first ambient temperature may be different from the second ambient temperature, the first charging time may be different from the second charging time, and the first refresh rate may be different from the second refresh rate. And a first brightness produced by the capacitor/capacitors of each pixel of the display screen 42 charged to the saturation state at the first ambient temperature may approximately equal to a second brightness produced by the capacitor/capacitors of each pixel of the display screen 42 charged to the saturation state at the second ambient temperature.

In some embodiments of the present disclosure, if the first ambient temperature is higher than the second ambient temperature, the first charging time may be shorter than the second charging time, and the first refresh rate may be higher than the second refresh rate.

In some embodiments, the display screen 42 may include a controller. The controller of the display screen 42 receives the charging time parameters transmitted by the processor 41, and accordingly modifies charging time parameters of each pixel of the display screen 42 so that the capacitor of each pixel of the second display screen 42 is charged according to the charging time parameters sent by the processor 41.

In some embodiments, the controller of the display screen 42 may receive the refresh rate parameters transmitted by the processor 41, and accordingly modifies refresh rate parameters of each pixel of the display screen 42 so that the capacitor of each pixel of the second display screen 42 is charged according to the refresh rate parameters sent by the processor 41.

The electronic device provided by the present disclosure may include a temperature measurement device. The temperature measurement device may include a P- sensor, and/or a temperature sensor, and/or a thermosensitive circuit, etc. The thermosensitive circuit may be integrated in a display screen.

If the temperature measurement device is a P-sensor, the P-sensor may be configured to receive an infrared signal emitted by an external object and to determine the ambient temperature by an infrared wavelength.

If the temperature measurement device is a thermosensitive circuit, a temperature corresponding to a resistance of the thermosensitive circuit may be determined according to the resistance of the thermosensitive circuit, and the corresponding temperature is the ambient temperature.

It should be noted that, each embodiment in the description is described in a progressive manner. That is, each embodiment focuses more on the differences from other embodiments, and for those same or similar parts in the embodiments, references may be made to the description thereof.

It should also be noted that relational terms such as “first” and “second” are merely used to distinguish one entity or operation from another entity or operation without necessarily requiring or implying that there is any such actual relationship or order between the entities or operations. Moreover, the terms “include,” “include,” or any other variations thereof are intended to cover a non-exclusive inclusion such that a process, method, article, or apparatus that includes a list of elements covers not only those elements but also other elements that are inherent to such process, method, article, or apparatus. Without further limitations, an element limited by the statement “including a . . . ” does not exclude the existence of additional equivalent elements in the process, method, article, or apparatus that includes the claimed element.

It should be understood that, in the embodiments of the present application, the embodiments and features corresponding to dependent claims may be combined with each other to achieve solutions to the foregoing technical problems.

The foregoing provides the detailed description of embodiments provided in the present disclosure. Specific examples are used herein to describe principles and implementation manners of the present disclosure. The description of the foregoing embodiments is merely used to achieve an understanding of the method and core concept of the present disclosure. Meanwhile, those skilled in the art may make any modification to the specific implementation manners and application scope according to the concept of the present disclosure. In view of the above, the contents of the description should not be construed as limiting the present disclosure.

Other embodiments of the disclosure will be apparent to those skilled in the art from consideration of the specification and practice of the disclosure provided herein. It is intended that the specification and examples be considered as exemplary only, with a true scope and spirit of the disclosure being indicated by the claims.

What is claimed is:

1. A charging control method, comprising:
obtaining, through a processor, a first ambient temperature of an electronic device;
based on the ambient temperature, determining, through a processor, a first refresh rate corresponding to the ambient temperature; and
controlling, through a processor, a display screen of the electronic device to refresh at the first refresh rate so that each pixel of the display screen is charged in a refresh cycle.

2. The method of claim 1, wherein the display screen displays at a same brightness level under different ambient temperatures.

3. The method of claim 2, wherein:
the display screen of the electronic device is refreshed at the first refresh rate in response to the electronic device being at the first ambient temperature, and the pixels of the display screen are charged in a first charging time to reach a saturation state; and
the display screen of the electronic device is refreshed at a second refresh rate in response to the electronic device being at a second ambient temperature, and the pixels of the display screen are charged in a second charging time to reach a saturation state, wherein:
the first ambient temperature is different from the second ambient temperature, the first refresh rate is different from the second refresh rate, and the first charging time is different from the second charging time, and
a first brightness level produced by the pixels of the display screen at the first ambient temperature approximately equals to a second brightness level produced by the pixels of the display screen at the second ambient temperature.

4. The method of claim 2, further comprising: controlling the display screen to modify charging time parameters of each pixel of the display screen based on the first refresh rate.

5. The method of claim 4, further comprising: a period for refreshing each frame of a screen image is a sum of charging times for charging each pixel of the display screen, the first refresh rate being the number times the screen image is refreshed per second.

6. The method of claim 1, further comprising: obtaining, through a temperature measurement device coupled to the processor, the first ambient temperature of the environment of the electronic device, and the temperature measurement device including one or more of a P-sensor, a temperature sensor, or a thermosensitive circuit.

7. The method of claim 6, wherein the thermosensitive circuit is integrated in the display screen.

8. The method of claim 1, further comprising: determining, through a processor, the first refresh rate corresponding to the first ambient temperature according to a correspondence between the first ambient temperature and the first refresh rate.

9. The method of claim 1, further comprising: determining, through a processor, the first refresh rate corresponding to the ambient temperature according to charging saturation time of a pixel in the display screen at the first ambient temperature.

10. A method for charging pixels in electronic device, comprising:
obtaining, through a processor, an ambient temperature of the electronic device;
based on the ambient temperature, determining, through a processor, charging time corresponding to the ambient temperature; and
controlling, through a processor, a display screen of the electronic device to charge each pixel of the display screen during the charging time.

11. The method of claim 10, wherein:
each pixel of the display screen is charged during a first charging time to reach a saturation state in response to the electronic device being at a first ambient temperature; and
each pixel of the display screen is charged during a second charging time to reach a saturation state in response to the electronic device being at a second ambient temperature, wherein:
the first ambient temperature is different from the second ambient temperature, and the first charging time is different from the second charging time, and
a first brightness level produced by each pixel of the display screen charged to the saturation state at the first ambient temperature approximately equals to a second brightness level produced by each pixel of the display screen charged to the saturation state at the second ambient temperature.

12. The method of claim 10, wherein the display screen displays at a same brightness level under different ambient temperatures.

13. The method of claim 10, wherein a refresh rate is determined according to a correspondence between the charging time and the refresh rate.

14. An electronic device, comprising:
a processor;
a display screen coupled to the processor; and
a storage medium coupled to the processor and configured to store an executable program that, when executed by the processor, causes the processor to:
obtain an ambient temperature of the electronic device;
based on the ambient temperature, determine a refresh rate corresponding to the ambient temperature; and
control the display screen to refresh at the refresh rate so that each pixel of the display screen is charged in a refresh cycle.

15. The electronic device of claim 14, wherein the display screen displays at a same brightness level under different ambient temperatures.

16. The electronic device of claim 15, wherein:
the processor is configured to:
refresh the display screen at a first refresh rate in response to the electronic device being at a first ambient temperature, each pixel of the display screen is charged during a first charging time to reach a saturation state; and
refresh the display screen at a second refresh rate in response to the electronic device being at a second ambient temperature, each pixel of the display screen is charged during a second charging time to reach a saturation state;
the first ambient temperature is different from the second ambient temperature, the first refresh rate is different from the second refresh rate, and the first charging time is different from the second charging time; and
a first brightness level produced by each pixel of the display screen charged to the saturation state at the first ambient temperature approximately equals to a second brightness level produced by each pixel of the display screen charged to the saturation state at the second ambient temperature.

17. The electronic device of claim 15, wherein: the display screen further includes a controller, and the processor controls the controller to modify charging time parameters of each pixel of the display screen based on the refresh rate.

18. The electronic device of claim 17, wherein a period for refreshing each frame of a screen image is a sum of charging times for charging each pixel of the display screen, the refresh rate being the number times the screen image is refreshed per second.

19. The electronic device of claim 14, further comprising a temperature measurement device coupled to the electronic device to obtain the ambient temperature, the temperature measurement device including one or more of a P-sensor, a temperature sensor, or a thermosensitive circuit.
